(19) United States
(12) Patent Application Publication
(10) Pub. No.: US 2024/0113849 A1
(43) Pub. Date: Apr. 4, 2024

(54) SUBBAND FULL DUPLEXING IN FREQUENCY DIVISION DUPLEXING BANDS

(71) Applicant: QUALCOMM Incorporated, San Diego, CA (US)

(72) Inventors: Muhammad Sayed Khairy Abdelghaffar, San Jose, CA (US); Tingfang Ji, San Diego, CA (US); Naga Bhushan, San Diego, CA (US); Krishna Kiran Mukkavilli, San Diego, CA (US)

(21) Appl. No.: 17/956,375

(22) Filed: Sep. 29, 2022

(51) Int. Cl. H04L 5/14; H04L 5/00; H04W 72/04

(52) U.S. Cl. CPC H04L 5/1438; H04L 5/003; H04L 5/143; H04W 72/0453

(57) ABSTRACT

Methods, systems, and devices for wireless communications are described. For example, an operator may utilize the duplexing gap as a second downlink channel for an operator that has an uplink channel next to the guard. an operator may utilize the duplexing gap as a second uplink channel for an operator that has a downlink channel next to the guard. In some examples, a new block may be added for an operator (e.g., the first operator, the second operator, or a third and distinct operator). The new block may include an uplink channel and a downlink channel (which are adjacent to respective uplink and downlink channels for other operators, hence avoiding additional interference). A new block may be added for an operator (e.g., the first operator, the second operator, or a third and distinct operator), which may be subdivided in time, frequency, or both.

### FIELD OF TECHNOLOGY

The following relates to wireless communications, including subband full duplexing (SBFD) in frequency division duplexing (FDD) bands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support subband full duplexing (SBFD) in frequency division duplexing (FDD) bands. In some examples, an operator may utilize a duplexing gap as a second downlink channel for an operator that has an uplink channel related to (e.g., next to) a guard. In some examples, an operator may utilize a duplexing gap as a second uplink channel for an operator that has a downlink channel related to (e.g., next to) a guard. In some examples, a new block may be added for an operator (e.g., the first operator, the second operator, a third operator). The new block may be associated with a new block channel and may include an uplink channel and/or a downlink channel (which may be next to respective uplink and downlink channels for other operators, hence avoiding additional interference). A gap may also be added to the new block channel. In some examples, the new block may be added for an operator (e.g., the first operator, the second operator, a third operator), which may be subdivided in time, frequency, or both. Portions of the subdivided block may be allocated to one or more different operators (e.g., a first operator may use a portion of the new block for signaling such as downlink or uplink signaling and may leave the remainder of the new block unused for another operator or as a guard).

A method for wireless communications at a network entity is described. The method may include selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels, determining one or more rules for subband full duplex (SBFD) signaling to be communicated to one or more user equipments (UEs) via the duplexing gap, and performing wireless communications with the one or more user equipment (UE)s via the duplexing gap according to a SBFD mode and based on the one or more rules.

An apparatus for wireless communications at a network entity is described. The apparatus may include a processor, memory coupled with the processor, and instructions stored in the memory. The instructions may be executable by the processor to cause the apparatus to select a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels, determine one or more rules for SBFD signaling to be communicated to one or more user equipments (UEs) via the duplexing gap, and perform wireless communications with the one or more UEs via the duplexing gap according to a SFBD mode and based on the one or more rules.

Another apparatus for wireless communications at a network entity is described. The apparatus may include means for selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels, means for determining one or more rules for SBFD signaling to be communicated to one or more user equipments (UEs) via the duplexing gap, and means for performing wireless communications with the one or more UEs via the duplexing gap according to a SBFD mode and based on the one or more rules.

A non-transitory computer-readable medium storing code for wireless communications at a network entity is described. The code may include instructions executable by a processor to select a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels, determine one or more rules for SBFD signaling to be communicated to one or more user equipments (UEs) via the duplexing gap, and perform wireless communications with the one or more UEs via the duplexing gap according to a SBFD mode and based on the one or more rules.

Some examples of the method, apparatuses, and non-transitory computer-readable medium described herein may further include operations, features, means, or instructions for selecting a block channel associated with a first operator, the block channel including a first uplink channel of the set of multiple uplink channels, a first downlink channel of the set of multiple downlink channels, and the duplexing gap, where performing the wireless communications via at least the duplexing gap includes performing the wireless communications via the block channel.

In some examples of the method, apparatuses, and non-transitory computer-readable medium described herein, performing the wireless communications may include operations, features, means, or instructions for transmitting downlink signaling via the duplexing gap, the duplexing gap including a second downlink channel of the block channel according to the one or more rules, where the first uplink channel may be adjacent to the duplexing gap.

In some examples of the method, apparatuses, and non-transitory computer-readable medium described herein, performing the wireless communications may include operations, features, means, or instructions for receiving uplink signaling via the duplexing gap, the duplexing gap including a second uplink channel of the block channel according to the one or more rules, where the first downlink channel may be adjacent to the duplexing gap.

In some examples of the method, apparatuses, and non-transitory computer-readable medium described herein, performing the wireless communications may include operations, features, means, or instructions for performing the wireless communications according to an emissions threshold.

Some examples of the method, apparatuses, and non-transitory computer-readable medium described herein may further include operations, features, means, or instructions for refraining from performing wireless communications via a guard band located in a portion of the duplexing gap.

Some examples of the method, apparatuses, and non-transitory computer-readable medium described herein may further include operations, features, means, or instructions for selecting a block channel associated with a first operator, the block channel including a first portion of the duplexing gap allocated for uplink signaling and a second portion of the duplexing gap allocated for downlink signaling, where performing the wireless communications via at least the duplexing gap includes performing the wireless communications via the block channel.

In some examples of the method, apparatuses, and non-transitory computer-readable medium described herein, the first portion of the duplexing gap may be adjacent to a first uplink channel of the set of multiple uplink channels that may be associated with a second operator according to the one or more rules and the second portion of the duplexing gap may be adjacent to a first downlink channel of the set of multiple downlink channels that may be associated with a third operator according to the one or more rules.

Some examples of the method, apparatuses, and non-transitory computer-readable medium described herein may further include operations, features, means, or instructions for refraining from performing wireless communications via a guard band located between the first portion of the duplexing gap and the second portion of the duplexing gap.

Some examples of the method, apparatuses, and non-transitory computer-readable medium described herein may further include operations, features, means, or instructions for selecting a block channel associated with a first operator, the block channel including a first portion of the duplexing gap allocated for uplink signaling and a second portion of the duplexing gap allocated for downlink signaling, where performing the wireless communications via at least the duplexing gap includes performing the wireless communications via the first portion of the duplexing gap or the second portion of the duplexing gap based on the one or more rules.

In some examples of the method, apparatuses, and non-transitory computer-readable medium described herein, performing the wireless communications may include operations, features, means, or instructions for performing downlink signaling via the second portion of the duplexing gap, where the second portion of the duplexing gap may be adjacent to a first downlink channel of the set of multiple downlink channels that may be associated with the first operator, and where the first portion of the duplexing gap may be adjacent to a first uplink channel of the set of multiple uplink channels that may be associated with a second operator and refraining from performing uplink signaling via the first portion of the duplexing gap according to the one or more rules.

In some examples of the method, apparatuses, and non-transitory computer-readable medium described herein, performing the wireless communications may include operations, features, means, or instructions for performing uplink signaling via the first portion of the duplexing gap, where the first portion of the duplexing gap may be adjacent to a first uplink channel of the set of multiple uplink channels that may be associated with the first operator, and where the second portion of the duplexing gap may be adjacent to a first downlink channel of the set of multiple downlink channels that may be associated with a second operator and refraining from performing downlink signaling via the second portion of the duplexing gap according to the one or more rules.

### BRIEF DESCRIPTION OF THE DRAWINGS

FIG. 1 illustrates an example of a wireless communications system that supports subband full duplexing (SBFD) in frequency division duplexing (FDD) bands in accordance with one or more aspects of the present disclosure.

FIG. 2 illustrates an example of a wireless communications system that supports SBFD in FDD bands in accordance with one or more aspects of the present disclosure.

FIG. 3 illustrates an example of a wireless communications system that supports SBFD in FDD bands in accordance with one or more aspects of the present disclosure.

FIG. 4 illustrates an example of a wireless communications system that supports SBFD in FDD bands in accordance with one or more aspects of the present disclosure.

FIG. 5 illustrates an example of a wireless communications system that supports SBFD in FDD bands in accordance with one or more aspects of the present disclosure.

FIG. 6 illustrates an example of a wireless communications system that supports SBFD in FDD bands in accordance with one or more aspects of the present disclosure.

FIG. 7 illustrates an example of a wireless communications system that supports SBFD in FDD bands in accordance with one or more aspects of the present disclosure.

FIG. 8 illustrates an example of a process flow that supports SBFD in FDD bands in accordance with one or more aspects of the present disclosure.

FIGS. 9 and 10 show block diagrams of devices that support SBFD in FDD bands in accordance with one or more aspects of the present disclosure.

FIG. 11 shows a block diagram of a communications manager that supports SBFD in FDD bands in accordance with one or more aspects of the present disclosure.

FIG. 12 shows a diagram of a system including a device that supports SBFD in FDD bands in accordance with one or more aspects of the present disclosure.

FIGS. 13 through 16 show flowcharts illustrating methods that support SBFD in FDD bands in accordance with one or more aspects of the present disclosure.

### DETAILED DESCRIPTION

In some examples, network entities and user equipments (UEs) may operate in frequency division duplexing (FDD) bands (e.g., low spectrum bands) including block channels (e.g., multiple channels, including an uplink channel and a downlink channel aggregated together into a single block channel). Each operator may be allocated block channels including one uplink channel and one downlink channel, where downlink channels and uplink channels (e.g., seven uplink channels and seven downlink channels) may be separated by a duplexing gap (e.g., 652 MHz to 663 MHz in a 600 MHz band). The duplexing gap be a subset of frequency resources, located between uplink channels and downlink channels, and may support uplink signaling by one operator adjacent to the duplexing gap, and downlink signaling by another operator adjacent to the duplexing gap, without interference. However, the resources of the duplexing gap may in some examples remain unused and may be wider than necessary to provide a sufficient duplexing gap—resulting in reduced throughput and less efficient use of available system resources. Wireless devices (e.g., network entities, access points, etc.) may be capable of subband full duplex (SBFD) techniques, which may support full duplex signaling within a single channel or subband (e.g., without causing increased interference to the subbands or channels). Such SBFD techniques may support use of the duplexing gap. However, in other different wireless communication systems, use of the duplexing gap by one operator may cause interference to another operator in another channel.

Techniques described herein describe rules and use case scenarios in which one operator may more-effectively utilize the duplexing gap without causing interference for another operator. In some examples, an operator may utilize the duplexing gap as a second downlink channel for an operator that has an uplink channel next to the guard. The operator may use, in some examples, a three-channel block channel (e.g., an uplink channel, a downlink channel, and a second downlink channel in the duplexing gap). The interference from the second downlink channel to an adjacent uplink channel for the same operator is addressed via the SBFD technology. An additional gap may also be applied to the duplexing gap or the adjacent downlink channel.

In some examples, an operator may utilize the duplexing gap as a second uplink channel for an operator that has a downlink channel next to the guard. The operator may use, in some examples, a three channel block channel (e.g., an uplink channel, a downlink channel, and a second uplink channel in the duplexing gap). The interference from the second uplink channel to an adjacent downlink channel for the same operator is addressed via the SBFD technology. An additional gap may also be applied to the duplexing gap or the adjacent uplink channel.

In some examples, a new block may be added for an operator (e.g., the first operator, the second operator, or a third distinct operator). The new block may include an uplink channel and a downlink channel (which are adjacent to respective uplink and downlink channels for other operators, hence avoiding additional interference). A gap may also be added to the new block channel.

In some examples, a new block may be added for an operator (e.g., the first operator, the second operator, a third operator), which may be subdivided in time, frequency, or both. Portions of the subdivided block may be allocated to one or more different operators (e.g., a first operator may use a portion of the new block for signaling such as downlink or uplink signaling and may leave the remainder of the new block unused for another operator or as a guard).

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to subband full duplexing (SBFD) in frequency division duplexing (FDD) bands.

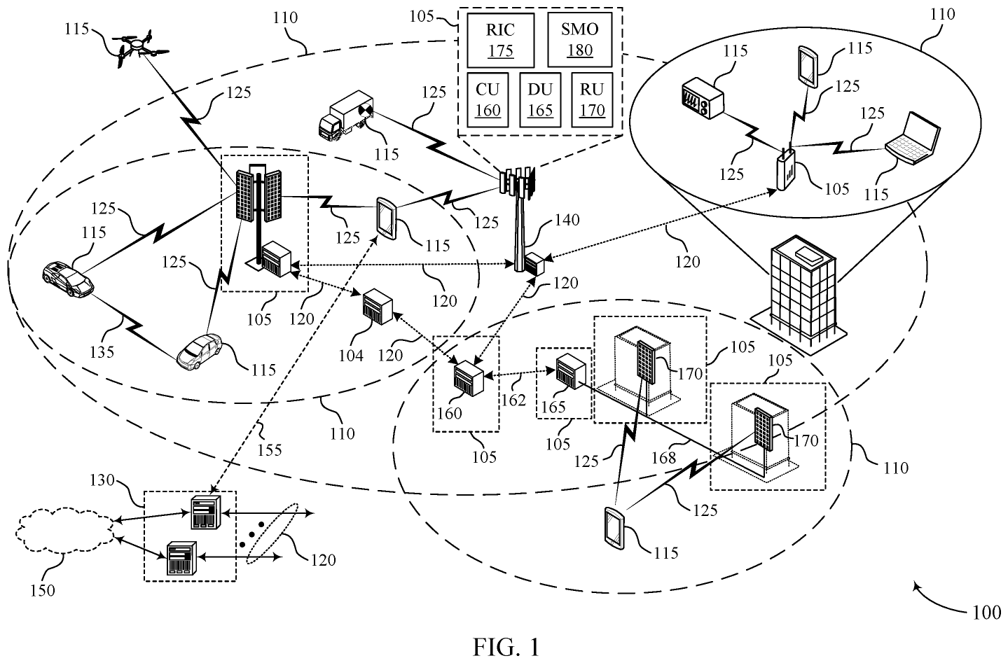

FIG. 1 illustrates an example of a wireless communications system 100 that supports SBFD in FDD bands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support SBFD in FDD bands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a subband, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more subbands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, an operator may utilize the duplexing gap as a second downlink channel for an operator that has an uplink channel next to the guard. an operator may utilize the duplexing gap as a second uplink channel for an operator that has a downlink channel next to the guard. In some examples, a new block may be added for an operator (e.g., the first operator, the second operator, or a third and distinct operator). The new block may include an uplink channel and a downlink channel (which are adjacent to respective uplink and downlink channels for other operators, hence avoiding additional interference). A new block may be added for an operator (e.g., the first operator, the second operator, or a third and distinct operator), which may be subdivided in time, frequency, or both.

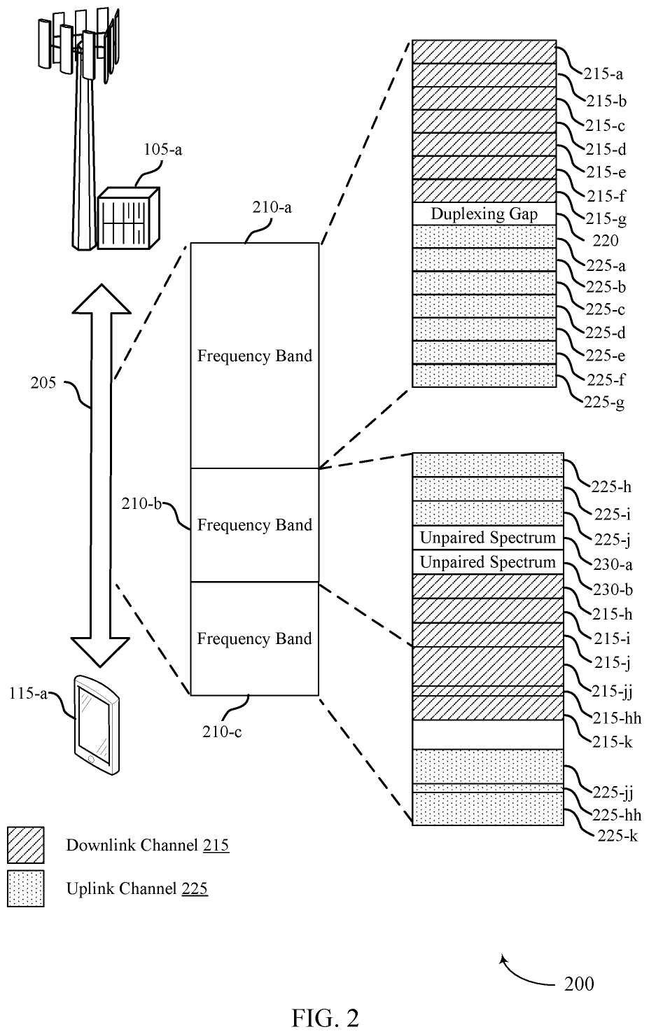

FIG. 2 illustrates an example of a wireless communications system 200 that supports SBFD in frequency division duplexing bands in accordance with one or more aspects of the present disclosure. In some examples, the wireless communications system 200 may implement aspects of wireless communications system 100. For instance, a UE (e.g., a UE 115) and a network entity (e.g., a network entity 105), which may be examples of corresponding devices described with reference to FIGS. 1, may communicate according to wireless communications system 200.

The wireless communications system 200 may include a network entity 105-a, which may be an example of a network entity 105 as described herein. The wireless communications system 200 may also include a UE 115-a which may be an example of a UE 115 as described herein. In some examples the network entity 105-a and the UE 115-a may communicate via one or more communication links 205.

The network entity 105-a and the UE 115-a may each be configured to communicate according to a full-duplex communication configuration (e.g., supportive of both downlink communications and uplink communications simultaneously). For example, the one or more communication links 205 may be used for downlink communications, uplink communications, or both. In SBFD techniques, uplink and downlink communications are transmitting in overlapping (e.g., either fully or partially) time resources but non-overlapping frequency resources. In order to avoid or reduce cross-link interference, the non-overlapping frequency resources may be separated by a guard band. In some examples, the guard band may also be referred to as a duplexing gap 220.

The UE 115-a and network entity 105-a may communicate via the one or more communication links 205 in a full duplex frequency band. In some cases, the network entity 105-a may operate in one or more FDD bands (e.g., low spectrum may be used for NR FDD operations) including one or more block channels (e.g., channels that include multiple adjacent or non-adjacent channels or subchannels). For example, a frequency band 210-a may represent a 600 MHz band which may span from approximately 617 MHz to 698 MHz for a total bandwidth of 81 MHz. The 600 MHz band may also be referred to as a n71 band.

In some examples, frequency band 210-a may be divided into downlink channels 215 and uplink channels 225. Although illustrated with reference to FIG. 2, techniques described herein may be similarly applied to any band or subband. For example, as shown in FIG. 2 for illustrative purposes, frequency band 210-a may be divided into seven block channels. In some cases, each of the block channels may include paired spectrum (e.g., a downlink channel 215 and an uplink channel 225). For example, a first block channel may define paired spectrum including a downlink channel 215-a and an uplink channel 225-a, a second block channel may define paired spectrum including a downlink channel 215-b and an uplink channel 225-b, a third block channel may define paired spectrum including a downlink channel 215-c and an uplink channel 225-c, a fourth block channel may define paired spectrum including a downlink channel 215-d and an uplink channel 225-d, a fifth block channel may define paired spectrum including a downlink channel 215-e and an uplink channel 225-e, a sixth block channel may define paired spectrum including a downlink channel 215-f and an uplink channel 225-f, and a seventh block channel may define paired spectrum including a downlink channel 215-g and an uplink channel 225-g.

In some instances, an operator may be allocated at least one or more block channels paired across at least one uplink channel and one downlink channel. For example, a first operator may be allocated the first block channel, that includes the downlink channel 215-a and the uplink channel 225-a, and the second operator may be allocated the second block channel that includes the downlink channel 215-b and the uplink channel 225-b. Each block channel may have approximately a bandwidth of 10 MHz that is divided equally as 5 MHz spectrum for the downlink channel 215 and 5 MHz spectrum for the uplink channel 225.

In some cases, a duplexing gap 220 may be located in the frequency band 210-a. More specifically, the duplexing gap 220 may be in between the downlink channels 215 and the uplink channels 225. For instance, the 600 MHz band may contain a duplexing spectrum gap of approximately 11 MHz (e.g., 652 MHz to 663 MHz). In this instance, the duplexing gap may account for approximately 13.5% of the frequency resources of the 600 MHz band.

In some cases, the duplexing gap 220 may avoid or reduce cross-link interference (e.g., interference caused by uplink and downlink transmissions in overlapping time intervals). For example, the duplexing gap 220 may support uplink signaling by a first operator, adjacent to the duplexing gap, and downlink signaling by a second operator, also adjacent to the duplexing gap, without interference. Using FIG. 2 as an illustrative example, duplexing gap 220 may protect the downlink transmissions for the first operator (allocated to the downlink channel 215-g) from interference (e.g., jamming) from the uplink transmissions for the second operator (allocated to the uplink channel 225-a). However, the duplexing gap may result in system inefficiencies because significant frequency resources remain unutilized, resulting in decreased throughout, increased system latency, and decreased user experience.

In some examples, a frequency band 210-b and a frequency band 210-c may be divided into downlink channels 215 and uplink channels 225. The frequency band 210-b and the frequency band 210-c may represent a lower 700 MHz band and an upper 700 MHz band, respectively. In some cases, each respective block channel may define paired spectrum including at least two or more channels. For example, a first block channel may include a pair of two 6 MHz channels (e.g., an uplink channel 225-h (frequency ranges from approximately 698 MHz to 704 MHz) and a downlink channel 215-h (frequency ranges from approximately 728 MHz to 738 MHz)) for a total bandwidth of 12 MHz. A second block channel may include a pair of two 6 MHz channels (e.g., an uplink channel 225-i (frequency ranges from approximately 704 MHz to 710 MHz) and a downlink channel 215-i (frequency ranges from approximately 734 MHz to 740 MHz)) for a total bandwidth of 12 MHz. A third block channel may include a pair of two 6 MHz channels (e.g., an uplink channel 225-j (frequency ranges from approximately 710 MHz to 716 MHz) and a downlink channel 215-j (frequency ranges from approximately 740 MHz to 746 MHz)) for a total bandwidth of 12 MHz. These first three block channel s may correspond to the n12 NR band. The third block channel may also include a pair of two 11 MHz channels (e.g., a downlink channel 215-jj (frequency ranges from approximately 746 MHz to 757 MHz) and an uplink channel 225-jj (frequency ranges from approximately 776 MHz to 787 MHz)) for a total bandwidth of 22 MHz in a n13 NR band. The fourth block channel may also include a pair of two 10 MHz channels (e.g., a downlink channel 215-k (frequency ranges from approximately 758 MHz to 768 MHz) and an uplink channel 225-k (frequency ranges from approximately 788 MHz to 798 MHz)) for a total bandwidth of 20 MHz in a n14 NR band. The first block channel may include two 1 MHz channels (e.g., a downlink channel 215-hh (frequency ranges from approximately 757 MHz to 758 MHz) and an uplink channel 225-hh (frequency ranges from approximately 787 MHz to 788 MHz)) for a total bandwidth of 2 MHz. Although described primarily with reference to a 600 MHz band and an upper and lower 700 MHz band with reference to FIG. 2, techniques described herein may be similarly applied to any band or subband (e.g., frequency band 210-a, frequency band 210-b, and frequency band 210-c may be examples of any ranges of frequency resources).

In some cases, the frequency band 210-b and/or the frequency band 210-c may contain unpaired channels that may function as a duplexing gap. For example, unpaired spectrum 230-a and unpaired spectrum 230-b may be located in between the uplink channel 225-j and the downlink channel 215-h. Unpaired spectrum 230-a (frequency ranges from approximately 716 MHz to 722 MHz) and unpaired spectrum 230-b (frequency ranges from approximately 722 MHz to 728 MHz) may be utilized, or may be utilized without including them in a block channel (e.g., including multiple channels). In some instances, unpaired spectrum may function as the duplexing gap 220 as described with reference to FIG. 2.

In some cases, a duplexing gap 220 (e.g., or unpaired spectrum 230 operating as a duplexing gap) may include one or more unoccupied frequency resources. The duplexing gap 220 may support uplink signaling by one operator adjacent to the duplexing gap and downlink signaling by another operator adjacent to the duplexing gap, without interference. However, the resources of the duplexing gap 220 may remain unutilized, resulting in reduced throughput and less efficient use of available system resources. The network entity 105-a may be capable of SBFD techniques, which may support full duplex signaling within a single channel or subband (e.g., without causing increased interference to the subbands or channels). Such SBFD techniques may support use of the duplexing gap 220 and/or unpaired spectrum 230. However, use of the duplexing gap 220 by one operator may cause interference to another operator in another channel.

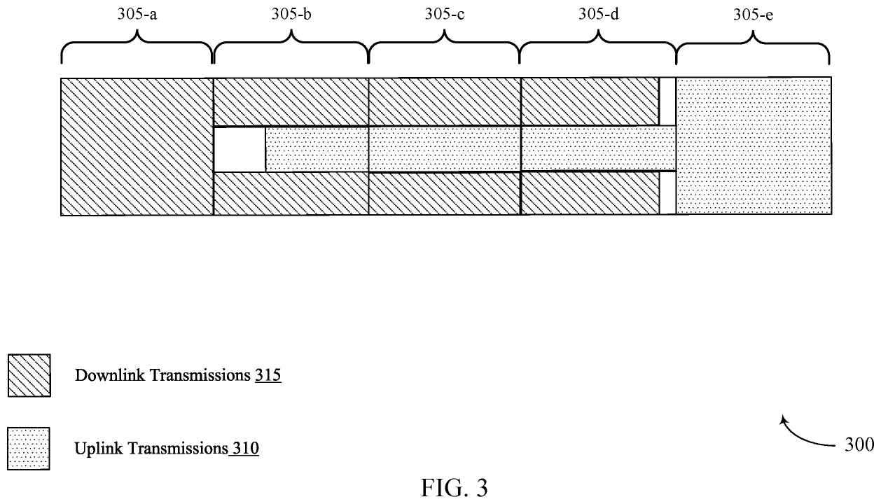

Techniques described herein may support one or more rules for SBFD in frequency division duplexing bands as described in more detail with reference to FIGS. 3-8. In some examples, frequency resources in the duplexing gap 220 may be allocated to a first operator without causing interference to another operator. For example, the first operator may utilize the duplexing gap 220 as an additional downlink channel 215 or an additional uplink channel 225 without causing interference to another operator, if such an allocation of resources conforms to one or more rules or conditions. In this way, the frequency resources of the duplexing gap 220 may be more efficiently used, increasing throughput, reducing system latency, and improving user experience.

FIG. 3 illustrates an example of a wireless communications system 300 that supports SBFD in FDD bands in accordance with one or more aspects of the present disclosure. 300 that supports SBFD in frequency division duplexing bands in accordance with one or more aspects of the present disclosure. In some examples, the wireless communications system 300 may implement aspects of wireless communications system 200. For instance, a UE (e.g., a UE 115) and a network entity (e.g., a network entity 105), which may be examples of corresponding devices described with reference to FIGS. 1-2, may communicate according to wireless communications system 300.

In some cases, a UE and a network entity may communicate according to SBFD techniques and technology. SBFD technology may enable the operation of downlink communication and uplink communication in the same TDD channels with no guard band or a very small guard band. For example, the downlink transmissions 315 and the uplink transmissions 310 may be transmitted in overlapping time resources, with little to no guard band, without interference (e.g., by having enough spatial isolation between a transmitting antenna panel and a receiving antenna panel, and in addition to digital cancellation of the residual interference). For instance, the UE and the network entity may perform downlink transmissions 315 during time interval 305-a, and uplink transmissions 310 during time interval 305-e, and may support (e.g., by implementing SBFD technology) both uplink transmissions 310 and downlink transmissions 315 during time interval 305-b, time interval 305-c, and time interval 305-d.

In some cases, SBFD technology may allow a communications system (e.g., cellular system) to utilize the duplexing gap (e.g., the duplexing gap 220 described with reference to FIG. 2). In some examples, an operator with SBFD technology may utilize a duplexing gap (e.g., duplexing guard band) in an FDD band to improve spectrum utilization. Techniques described herein define rules and procedures to enable the use of duplexing gaps (e.g., based on SBFD technology) in FDD bands.

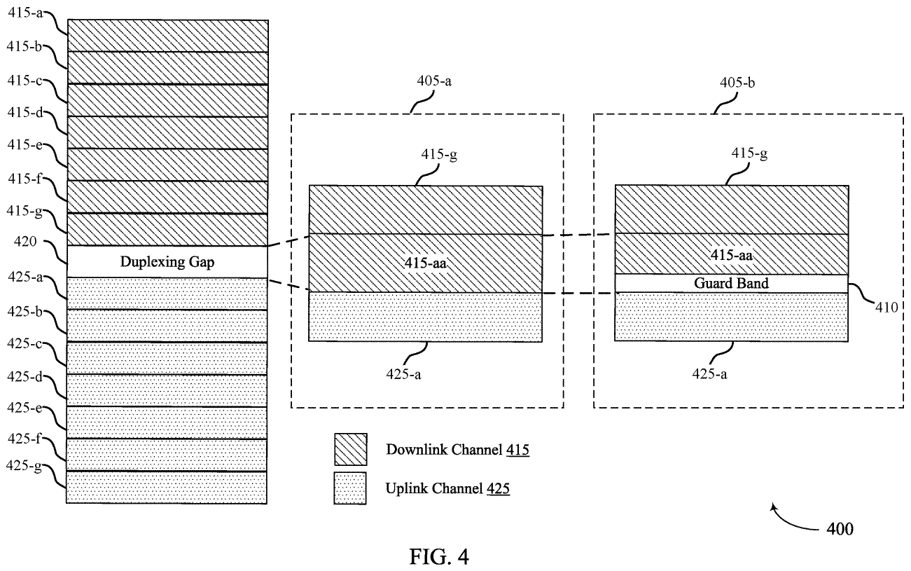

FIG. 4 illustrates an example of a wireless communications system 400 that supports SBFD in frequency division duplexing bands in accordance with one or more aspects of the present disclosure. In some examples, the wireless communications system 400 may implement aspects of wireless communications systems 100, 200, and 300. For instance, a UE (e.g., a UE 115) and a network entity (e.g., a network entity 105), which may be examples of corresponding devices described with reference to FIGS. 1-3, may communicate according to wireless communications system 400. In some examples, the wireless communications system 400 may support wireless communications on one or more bands (e.g., an FDD band) via one or more downlink channels 415 (e.g., the downlink channel 415-a, the downlink channel 415-b, the downlink channel 415-c, the downlink channel 415-d, the downlink channel 415-e, the downlink channel 415-f, and the downlink channel 415-e), one or more uplink channels 425 (e.g., the uplink channel 425-a, the uplink channel 425-b, the uplink channel 425-c, the uplink channel 425-d, the uplink channel 425-e, the uplink channel 425-f, and the uplink channel 425-g), or a combination thereof.

In some cases, a first operator may utilize a duplexing gap 420 as a second downlink channel 415-aa. For example, an operator that has (e.g., is allocated) an uplink channel 425-a next to (e.g., adjacent in frequency) to the duplexing gap 420 (e.g., where a second operator has a downlink channel 415-g that is also next to the duplexing gap 420) may utilize the duplexing gap 420 as a second downlink channel in a block channel. In some examples, the second downlink channel 415-aa may be paired to a block channel associated with the first operator. This block channel may be paired across three channels, including the second downlink channel 415-aa, a first downlink channel 425-a adjacent to the duplexing gap 420, and a first uplink channel 415-a (e.g., that is not adjacent to the duplexing gap 420). In a first example 405-a, the first uplink channel 425-a may have a frequency of 5 MHz (frequency ranges from approximately 633 to 688 MHz), the first downlink channel 415-g may have a frequency of 5 MHz (frequency ranges from approximately 617 to 622 MHz), and the second downlink channel 415-aa may have a frequency of 11 MHz (frequency ranges from approximately 652 to 663 MHz) for a total bandwidth of 21 MHz allocated to the first operator.

Any interference resulting from downlink channel 415-aa to an uplink channel of the same operator (e.g., the uplink channel 425-a) may be addressed using SBFD capabilities supported by the operator. Any interference resulting from the downlink channel 415-aa to an uplink channel 425-b (e.g., where the operator that has uplink channel 425-b is different than the operator utilizing the duplexing gap 420) may be mitigated or avoided due to the uplink channel 425-a acting as a guard between the downlink channel 415-aa and the uplink channel 425-b. In some examples, the transmitting device (e.g., the network entity transmitting via the downlink channel 415-aa) may be subject to an enhanced or restricted emission threshold (e.g., emission requirement or spectral mask) when communicating via the downlink channel 415-aa.

Additionally, or alternatively (e.g., in example 405-b), the duplexing gap 420 may not be fully utilized as a downlink channel (e.g., the downlink channel 415-aa). For instance, there may be a small guard band 410 between the downlink channel 415-aa and the uplink channel 425-a. This guard band 410 may have a smaller bandwidth than the duplexing gap 420. For example, the first uplink channel 425-a may have a bandwidth of 5 MHz (frequency ranges from approximately 633 to 668 MHz), the first downlink channel 415-g may have a bandwidth of 5 MHz (frequency ranges from approximately 617 to 644), and the second downlink channel may have a bandwidth of 6 MHz (frequency ranges from approximately 652 to 658 MHz) for a total bandwidth of 16 MHz allocated to the block channel. Thus, the guard band 410 may have a bandwidth of approximately 5 MHz. Although described primarily with reference to a 600 MHz band with reference to FIG. 4, techniques described herein may be similarly applied to any band or subband.

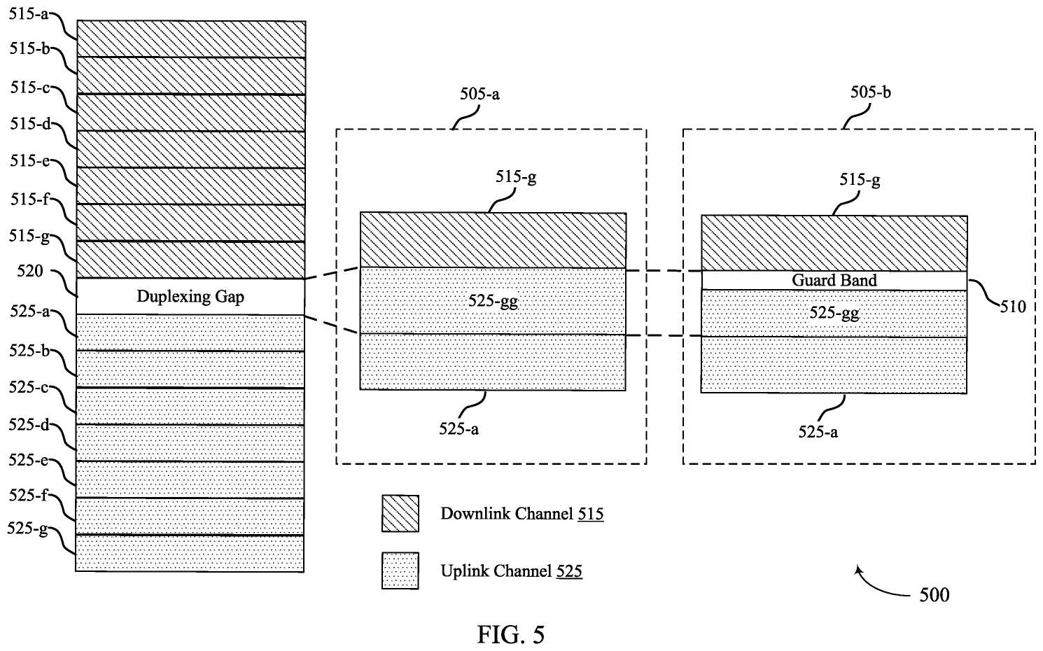

FIG. 5 illustrates an example of a wireless communications system 500 that supports SBFD in frequency division duplexing bands in accordance with one or more aspects of the present disclosure. In some examples, the wireless communications system 500 may implement aspects of wireless communications systems 100, 200, 300, and 400. For instance, a UE (e.g., a UE 115) and a network entity (e.g., a network entity 105), which may be examples of corresponding devices described with reference to FIGS. 1-4, may communicate according to wireless communications system 500. In some examples, the wireless communications system 500 may support wireless communications on one or more bands (e.g., an FDD band) via one or more downlink channels 515 (e.g., the downlink channel 515-a, the downlink channel 515-b, the downlink channel 515-c, the downlink channel 515-d, the downlink channel 515-e, the downlink channel 515-f, and the downlink channel 515-e), one or more uplink channels 525 (e.g., the uplink channel 525-a, the uplink channel 525-b, the uplink channel 525-c, the uplink channel 525-d, the uplink channel 525-e, the uplink channel 525-f, and the uplink channel 525-g), or a combination thereof.

In some cases, a first operator may utilize a duplexing gap 520 (e.g., duplexing guard) as a second uplink channel 525-gg. For example, an operator that has (e.g., is allocated) a downlink channel 515-g next to the duplexing gap 520 (e.g., where a second operator has an uplink channel 525-a that is also next to the duplexing gap 520) may utilize the duplexing gap 520 as a second uplink channel in a block channel. The duplexing gap 520 may represent the duplexing gap 220, as described with reference to FIG. 2. In some examples, the second uplink channel 525-gg may be paired to a block channel associated with the first operator. This block channel may be paired across three channels, including the second uplink channel 525-gg, a first downlink channel 515-g adjacent to the duplexing gap 520, and a first uplink channel 525-g (e.g., that is not adjacent to the duplexing gap 520). In a first example 505-a, the first uplink channel 525-g may have a frequency of 5 MHz (frequency ranges from approximately 693 to 698 MHz), the first downlink channel 515-g may have a frequency of 5 MHz (frequency ranges from approximately 647 to 652 MHz), and the second uplink channel 415-aa may have a frequency of 11 MHz (frequency ranges from approximately 652 to 663 MHz) for a total bandwidth of 21 MHz allocated to the first operator.

Any interference resulting from uplink channel 525-gg to an uplink channel of the same operator (e.g., the downlink channel 515-g) may be addressed using SBFD capabilities supported by the operator. Any interference resulting from the uplink channel 525-gg to the downlink channel 515-f (e.g., where the operator that has downlink channel 515-f is different than the operator utilizing the duplexing gap 420) may be mitigated or avoided due to the downlink channel 515-g acting as a guard between the uplink channel 525-gg and the downlink channel 515-f. In some examples, the transmitting device (e.g., the network entity transmitting via the uplink channel 525-gg) may be subject to an enhanced or restricted emissions threshold (e.g., emission requirement or spectral mask) when communicating via the uplink channel 525-gg.

Additionally, or alternatively (e.g., in example 505-b), the duplexing gap 520 may not be fully utilized as an uplink channel 525 (e.g., the uplink channel 525-gg). For instance, there may be a small guard band 510 between the downlink channel 515-g and the uplink channel 525-gg. This guard band 510 may have a smaller bandwidth than the duplexing gap 520, but still protect uplink channel 525-gg from interference. For example, the first uplink channel 525-g may have a frequency of 5 MHz (frequency ranges from approximately 693 to 698 MHz), the first downlink channel 515-g may have a frequency of 5 MHz (frequency ranges from approximately 647 to 652 MHz), and the second uplink channel 415-aa may have a frequency of 6 MHz (frequency ranges from approximately 652 to 663 MHz) for a total bandwidth of 16 MHz allocated to the first operator. Thus, the guard band 510 may have a bandwidth of approximately 5 MHz. Although described primarily with reference to a 600 MHz band with reference to FIG. 5, techniques described herein may be similarly applied to any band or subband.

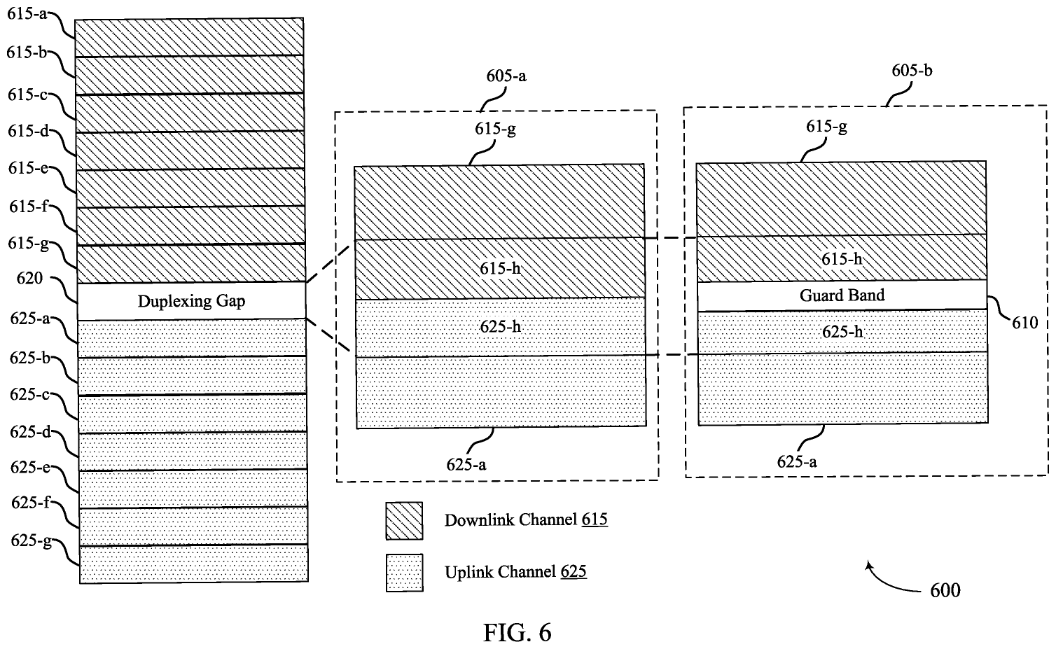

FIG. 6 illustrates an example of a wireless communications system 600 that supports SBFD in frequency division duplexing bands in accordance with one or more aspects of the present disclosure. In some examples, the wireless communications system 600 may implement aspects of wireless communications systems 100, 200, 300, 400, and 500. For instance, a UE (e.g., a UE 115) and a network entity (e.g., a network entity 105), which may be examples of corresponding devices described with reference to FIGS. 1-5, may communicate according to wireless communications system 600. In some examples, the wireless communications system 600 may support wireless communications on one or more bands (e.g., an FDD band) via one or more downlink channels 615 (e.g., the downlink channel 615-a, the downlink channel 615-b, the downlink channel 615-c, the downlink channel 615-d, the downlink channel 615-e, the downlink channel 615-f, and the downlink channel 615-e), one or more uplink channels 625 (e.g., the uplink channel 625-a, the uplink channel 625-b, the uplink channel 625-c, the uplink channel 625-d, the uplink channel 625-e, the uplink channel 625-f, and the uplink channel 625-g), or a combination thereof.

In some cases, a new paired channel (e.g., a new block channel) may be introduced within the duplexing gap 620. For example, a first operator (e.g., which may be SFDB capable) may utilize a first portion of a duplexing gap 620 (e.g., duplexing guard) for uplink signaling and a second portion of the duplexing gap 620 for downlink signaling. In a first example 605-a, the first operator may utilize the duplexing gap 620 as a first downlink channel 615-h and a first uplink channel 625-h with no guard band. For example, the first operator may be paired across the downlink channel 615-h with a bandwidth of 5.5 MHz (frequency ranges from approximately 652 to 657.5 MHz) and the uplink channel 625-h with a bandwidth of 5.5 MHz (frequency ranges from approximately 657.5 to 663 MHz) for a total bandwidth of 11 MHz allocated to the first operator. This first operator, as described with reference to FIG. 6, may represent the first operator as described with reference to FIG. 4, the first operator as described with reference to FIG. 5, or a different operator (e.g., a new operator). For example, the first operator that uses a new block channel within the duplexing gap 620 may be an operator associated with one or more downlink channels 615 (e.g., the downlink channel 615-g), or may be associated with one or more uplink channels 625 (e.g., the uplink channel 625-a), or may be a different (e.g., third) operator that is not associated with the downlink channel 615-g or the uplink channel 625-a.

In some cases (e.g., in second example 605-b), the first operator may utilize the duplexing gap 620 as a first downlink channel 615-h, a first uplink channel 625-h, and a guard band 630. The guard band 630 may be located between the first downlink channel 615-h and the first uplink channel 625-h and have a smaller bandwidth that the duplexing gap 620. For example, the downlink channel 615-h may have a bandwidth of 5 MHz (frequency ranges from approximately 652 to 657 MHz), the uplink channel 625-h may have a bandwidth of 5 MHz (frequency ranges from approximately 658 to 663 MHz), and the guard band 630 may have a bandwidth of 1 MHz for a total bandwidth of 10 MHz allocated to the block channel associated with the first operator. Although described primarily with reference to a 600 MHz band with reference to FIG. 6, techniques described herein may be similarly applied to any band or subband.

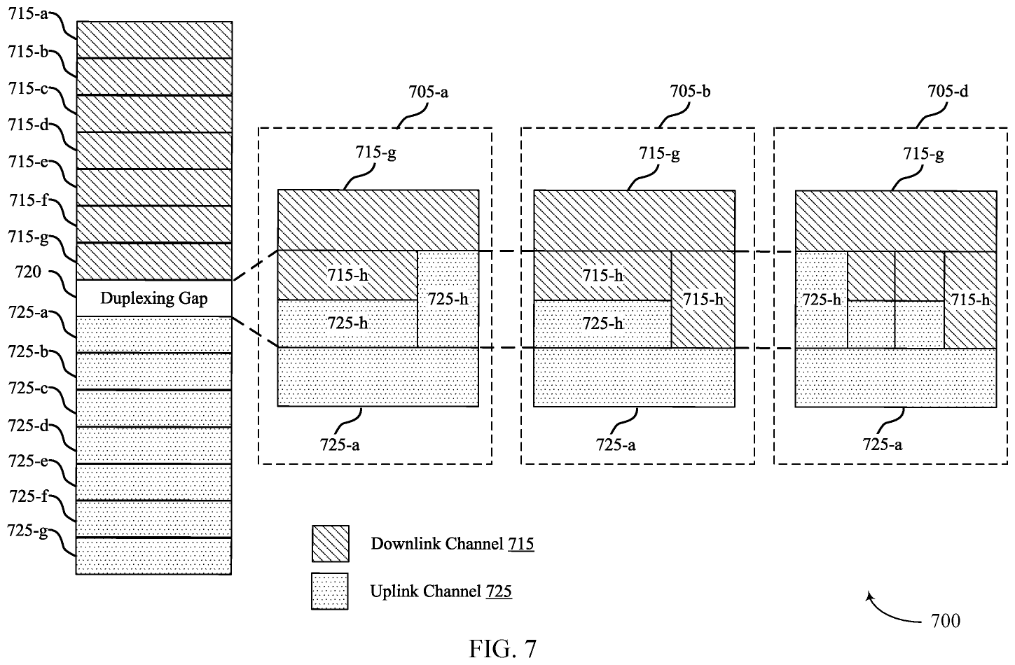

FIG. 7 illustrates an example of a wireless communications system 700 that supports SBFD in FDD bands in accordance with one or more aspects of the present disclosure. In some examples, the wireless communications system 700 may implement aspects of wireless communications systems 100, 200, 300, 400, 500, and 600. For instance, a UE (e.g., a UE 115) and a network entity (e.g., a network entity 105), which may be examples of corresponding devices described with reference to FIGS. 1-6, may communicate according to wireless communications system 700. In some examples, the wireless communications system 700 may support wireless communications on one or more bands (e.g., an FDD band) via one or more downlink channels 715 (e.g., the downlink channel 715-a, the downlink channel 715-b, the downlink channel 715-c, the downlink channel 715-d, the downlink channel 715-e, the downlink channel 715-f, and the downlink channel 715-e), one or more uplink channels 725 (e.g., the uplink channel 725-a, the uplink channel 725-b, the uplink channel 725-c, the uplink channel 725-d, the uplink channel 725-e, the uplink channel 725-f, and the uplink channel 725-g), or a combination thereof.

In some cases, a new block channel may be defined for the duplexing gap 420 to be used by an SBFD capable operator. For example, a new block channel, may include a downlink channel 715-h and an uplink channel 725-h.

In some examples, an operator may use a portion of the new block channel (e.g., the downlink channel 715-h) for downlink signaling, or a portion of the new block channel (e.g., the uplink channel 725-h), or both. In a first example 705-a), a first operator (e.g., associated with the downlink channel 715-g) may use the uplink channel 725-h (e.g., a portion of the new block channel in the duplexing gap 720) for uplink signaling (e.g., and may refrain from transmitting downlink signaling via the downlink channel 715 to avoid generating interference for any other channels owned by other operators).

In some examples (e.g., in second example 705-b), a second operator (e.g., associated with the uplink channel 725-a) may use the downlink channel 715-h (e.g., a portion of the new block channel in the duplexing gap) for downlink signaling (e.g., may refrain from using the uplink channel 725-h for uplink signaling to avoid generating interference for any other channels owned by other operators).

In some examples (e.g., in a third example 705-c), two operators (e.g., the first operator and the second operator, or one of the first operator or the second operator and a third operator), may share spectrum between the two operators in a TDD fashion. For example, a first operator may be associated with the uplink channel 725-h during a first portion of a time interval. The first operator and the second operator may share the new block channel during one or more (e.g., two) time intervals (e.g., the first operator communicates using the uplink channel 725-h and the second operator communicates using the downlink channel 715-h). During another time interval (e.g., a fourth time interval), one of the operators may use the resources of the duplexing gap 720 for the downlink channel 715-h.

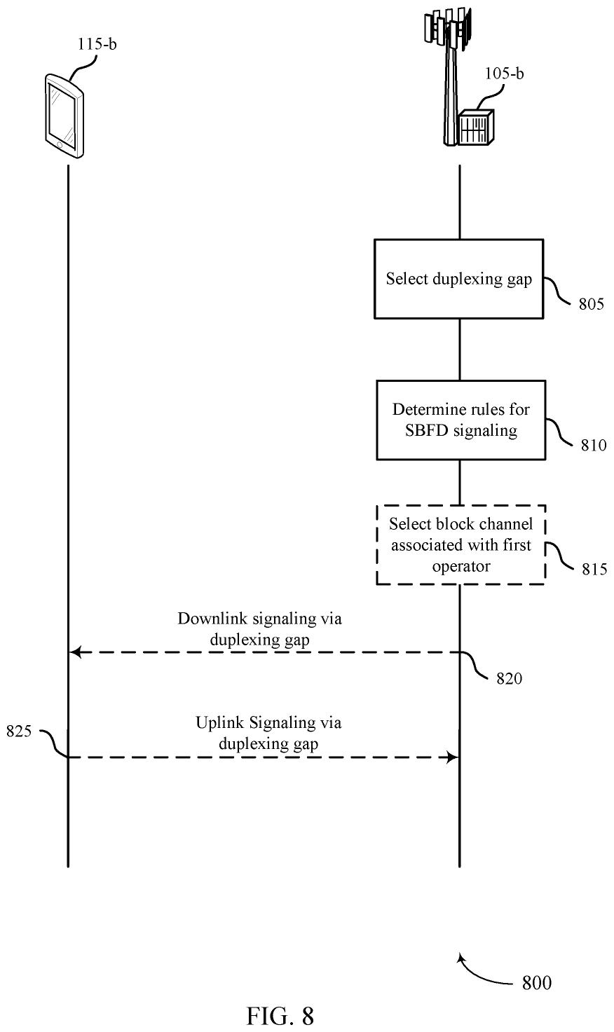

FIG. 8 illustrates an example of a process flow 800 that supports SBFD in FDD bands in accordance with one or more aspects of the present disclosure. The process flow 800 may implement aspects of, or be implemented by aspects of, wireless communications system 100, wireless communications system 200, wireless communications system 300, wireless communications system 400, wireless communications system 500, wireless communications system 600, and wireless communications system 700, or may be implemented by aspects of the wireless communications system 100, 200, 300, 400, 500, 600, and 700. For example, the process flow 800 may illustrate the operations between a UE 115-b and a network entity 105-b, which may be examples of corresponding devices described herein. In the following description of the process flow 800, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 800, or other operations may be added to the process flow 800.

At 805, the network entity 105-b may select a duplexing gap that is located between uplink channels in a first portion of a full duplex frequency band and downlink channels in a second portion of a full duplex frequency band. In some aspects, the duplexing gap may support uplink signaling by one operator adjacent to the duplexing gap and downlink signaling by another operator adjacent to the duplexing gap, without interference. However, the duplexing gap may contain unoccupied frequency resources, resulting in reduced throughput and less efficient use of available system resources.

At 810, the network entity 105-b may determine one or more rules for SBFD signaling to be communicated to one or more UEs (e.g., the UE 115-b) via the duplexing gap. In some aspects, an operator capable of SBFD signaling may utilize the duplexing gap (e.g., unpaired spectrum) as an additional downlink channel and/or an additional uplink channel without causing interference to another operator. In this way, the frequency resources of the duplexing gap may be used without introducing interference to other operators using other channels. The one or more rules for SBFD signaling may depend on the resources of the duplexing gap being allocated to at least a first operator. The one or more rules for SBFD signaling may also depend on which channels are paired with the block channel associated with the first operator (e.g., downlink channels and uplink channels) and where they are located. For example, if the block channel associated with the first operator includes a first uplink channel adjacent to the duplexing gap, the first operator may utilize the duplexing gap as a second downlink channel. Similarly, if the block channel associated with the first operator includes a first downlink channel adjacent to the duplexing gap, the first operator may utilize the duplexing gap as a second uplink channel. In such examples, the network entity 105-b may select a block channel associated with the first operator, according to the one or more rules, and communicate via the block channel (e.g., an extended block channel now including the resources of the duplexing gap and other channels, or a new block channel occupying the resources of the duplexing gap).

At 815, the network entity 105-b may select a block channel associated with a first operator, where the block channel includes at least a first uplink channel, a first downlink channel, and the duplexing gap. The network entity 105-b or the UE 115-b may perform any communications via the duplexing gap. That is, a first operator may transmit signaling via the duplexing gap (e.g., via the block channel including the duplexing gap) by utilizing at least a portion of the frequency resources of the duplexing gap that are now allocated to the block channel.

At 820, the network entity 105-b may transmit downlink signaling via the duplexing gap. That is, the network entity 105-b may transmit to the UE 115-b, downlink signaling via the duplexing gap if at least a portion of the duplexing is utilized as a second downlink channel according to the rules. For example, if the block channel associated with the first operator includes a first uplink channel adjacent to the duplexing gap, the first operator may utilize the duplexing gap as the second downlink channel. In some examples, the network entity 105-b may refrain from transmitting downlink signaling via a guard band located in a portion of the duplexing gap (e.g., at 820).

At 825, the network entity 105-b may receive (e.g., from the UE 115-b) uplink signaling via the duplexing gap. That is, the UE 115-b may transmit, to the network entity 105-b, uplink signaling via the duplexing gap if at least a portion of the duplexing gap is utilized as a second uplink channel for the operator according to the rules. For example, if the block channel associated with the first operator includes a first downlink channel adjacent to the duplexing gap, the second operator may utilize the duplexing gap as the second uplink channel. In some examples, the UE 115-b may refrain from transmitting uplink signaling via a guard band located in a portion of the duplexing gap (e.g., at 825).

In some examples, (e.g., as described with reference to FIG. 6), the network entity 105-b may select (e.g., at 815), a block channel associated with the first operator (e.g., which may or may not be an operator associated with the uplink channels or the downlink channels). The block channel may include a first portion of the duplexing gap allocated for uplink signaling and a second portion of the duplexing gap allocated for downlink signaling. At 820, 825, or both, the network entity 105-b may perform wireless communications via at least the duplexing gap by performing the wireless communications via the block channel.

In some examples, (e.g., as described with reference to FIG. 7), the network entity 105-b may select (e.g., at 815), a block channel associated with the first operator (e.g., which may or may not be an operator associated with the uplink channels or the downlink channels). The block channel may include a first portion of the duplexing gap allocated for uplink signaling and a second portion of the duplexing gap allocated for downlink signaling. The network entity 105-b may perform wireless communications via at least the duplexing gap by performing the wireless communications via the first portion of the duplexing gap or the second portion of the duplexing gap based at least in part on the one or more rules.

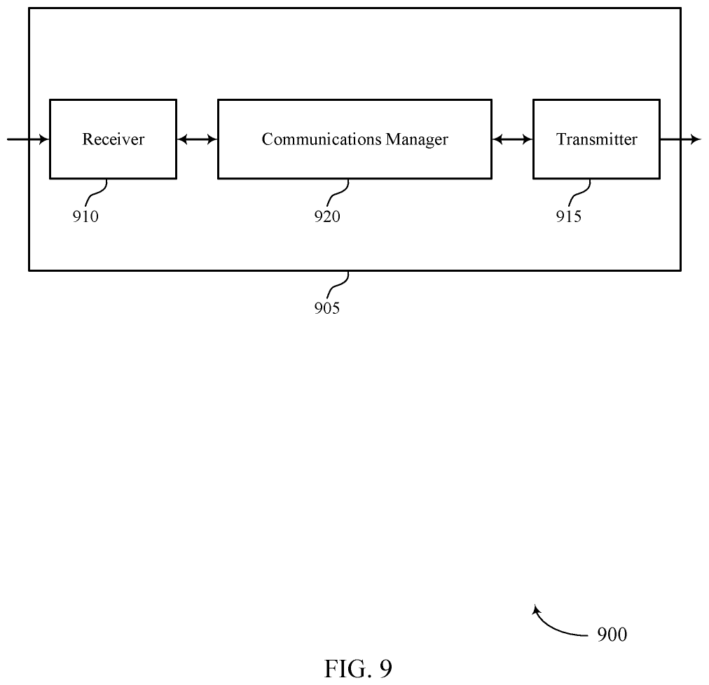

FIG. 9 shows a block diagram 900 of a device 905 that supports SBFD in FDD bands in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of SBFD in FDD bands as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The communications manager 920 may be configured as or otherwise support a means for determining one or more rules for SBFD signaling to be communicated to one or more user equipments (UEs) via the duplexing gap. The communications manager 920 may be configured as or otherwise support a means for performing wireless communications with the one or more UEs via the duplexing gap according to a SBFD full duplex mode and based on the one or more rules.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for effectively utilizing available system resources, including duplexing gaps, resulting in more efficient use of system resources, decreased system delays and latency, improved throughput, and improved user experiences.

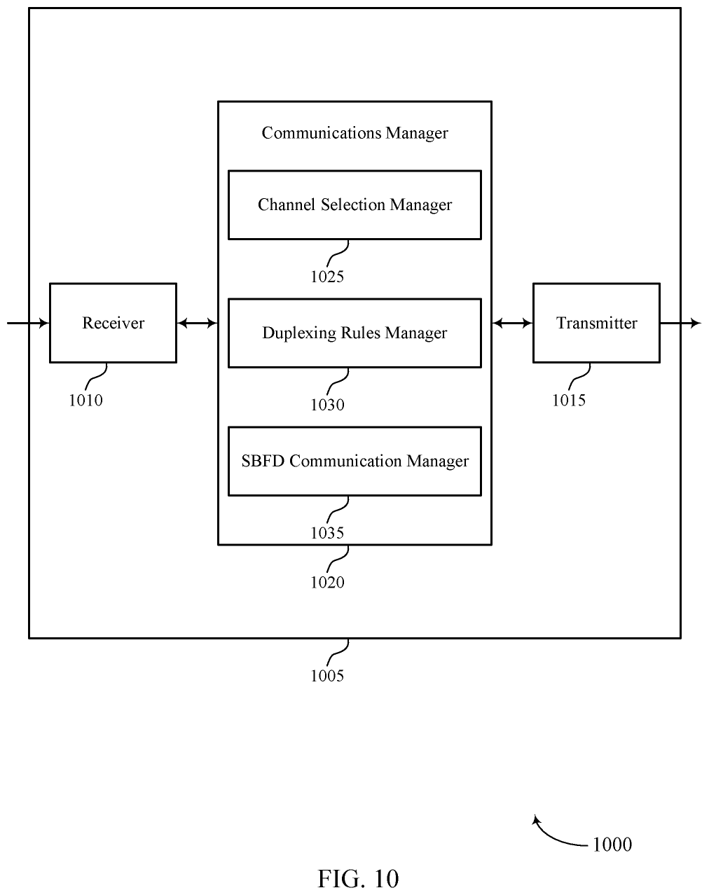

FIG. 10 shows a block diagram 1000 of a device 1005 that supports SBFD in FDD bands in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of SBFD in FDD bands as described herein. For example, the communications manager 1020 may include a channel selection manager 1025, a duplexing rules manager 1030, an SBFD communication manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The channel selection manager 1025 may be configured as or otherwise support a means for selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The duplexing rules manager 1030 may be configured as or otherwise support a means for determining one or more rules for SBFD signaling to be communicated to one or more user equipments (UEs) via the duplexing gap. The SBFD communication manager 1035 may be configured as or otherwise support a means for performing wireless communications with the one or more UEs via the duplexing gap according to a SBFD mode and based on the one or more rules.

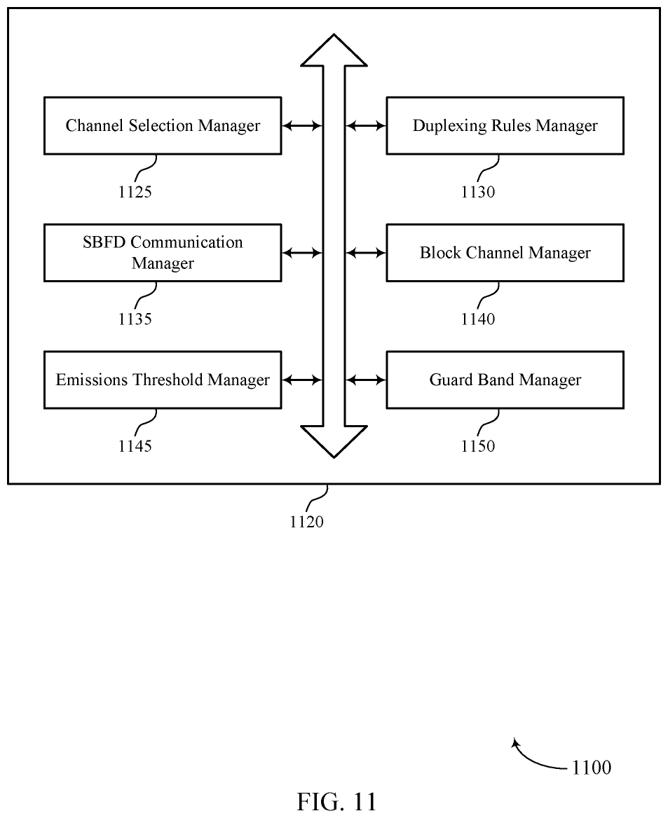

FIG. 11 shows a block diagram 1100 of a communications manager 1120 that supports SBFD in FDD bands in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of SBFD in FDD bands as described herein. For example, the communications manager 1120 may include a channel selection manager 1125, a duplexing rules manager 1130, an SBFD communication manager 1135, a block channel manager 1140, an emissions threshold manager 1145, a guard band manager 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The channel selection manager 1125 may be configured as or otherwise support a means for selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The duplexing rules manager 1130 may be configured as or otherwise support a means for determining one or more rules for SBFD signaling to be communicated to one or more user equipments (UEs) via the duplexing gap. The SBFD communication manager 1135 may be configured as or otherwise support a means for performing wireless communications with the one or more UEs via the duplexing gap according to a SBFD mode and based on the one or more rules.

In some examples, the block channel manager 1140 may be configured as or otherwise support a means for selecting a block channel associated with a first operator, the block channel including a first uplink channel of the set of multiple uplink channels, a first downlink channel of the set of multiple downlink channels, and the duplexing gap, where performing the wireless communications via at least the duplexing gap includes performing the wireless communications via the block channel.

In some examples, to support performing the wireless communications, the SBFD communication manager 1135 may be configured as or otherwise support a means for transmitting downlink signaling via the duplexing gap, the duplexing gap including a second downlink channel of the block channel according to the one or more rules, where the first uplink channel is adjacent to the duplexing gap.

In some examples, to support performing the wireless communications, the SBFD communication manager 1135 may be configured as or otherwise support a means for receiving uplink signaling via the duplexing gap, the duplexing gap including a second uplink channel of the block channel according to the one or more rules, where the first downlink channel is adjacent to the duplexing gap.

In some examples, to support performing the wireless communications, the emissions threshold manager 1145 may be configured as or otherwise support a means for performing the wireless communications according to an emissions threshold.

In some examples, the guard band manager 1150 may be configured as or otherwise support a means for refraining from performing wireless communications via a guard band located in a portion of the duplexing gap.

In some examples, the block channel manager 1140 may be configured as or otherwise support a means for selecting a block channel associated with a first operator, the block channel including a first portion of the duplexing gap allocated for uplink signaling and a second portion of the duplexing gap allocated for downlink signaling, where performing the wireless communications via at least the duplexing gap includes performing the wireless communications via the block channel.

In some examples, the first portion of the duplexing gap is adjacent to a first uplink channel of the set of multiple uplink channels that is associated with a second operator according to the one or more rules. In some examples, the second portion of the duplexing gap is adjacent to a first downlink channel of the set of multiple downlink channels that is associated with a third operator according to the one or more rules.

In some examples, the guard band manager 1150 may be configured as or otherwise support a means for refraining from performing wireless communications via a guard band located between the first portion of the duplexing gap and the second portion of the duplexing gap.

In some examples, the block channel manager 1140 may be configured as or otherwise support a means for selecting a block channel associated with a first operator, the block channel including a first portion of the duplexing gap allocated for uplink signaling and a second portion of the duplexing gap allocated for downlink signaling, where performing the wireless communications via at least the duplexing gap includes performing the wireless communications via the first portion of the duplexing gap or the second portion of the duplexing gap based on the one or more rules.

In some examples, to support performing the wireless communications, the SBFD communication manager 1135 may be configured as or otherwise support a means for performing downlink signaling via the second portion of the duplexing gap, where the second portion of the duplexing gap is adjacent to a first downlink channel of the set of multiple downlink channels that is associated with the first operator, and where the first portion of the duplexing gap is adjacent to a first uplink channel of the set of multiple uplink channels that is associated with a second operator. In some examples, to support performing the wireless communications, the SBFD communication manager 1135 may be configured as or otherwise support a means for refraining from performing uplink signaling via the first portion of the duplexing gap according to the one or more rules.

In some examples, to support performing the wireless communications, the SBFD communication manager 1135 may be configured as or otherwise support a means for performing uplink signaling via the first portion of the duplexing gap, where the first portion of the duplexing gap is adjacent to a first uplink channel of the set of multiple uplink channels that is associated with the first operator, and where the second portion of the duplexing gap is adjacent to a first downlink channel of the set of multiple downlink channels that is associated with a second operator. In some examples, to support performing the wireless communications, the SBFD communication manager 1135 may be configured as or otherwise support a means for refraining from performing downlink signaling via the second portion of the duplexing gap according to the one or more rules.

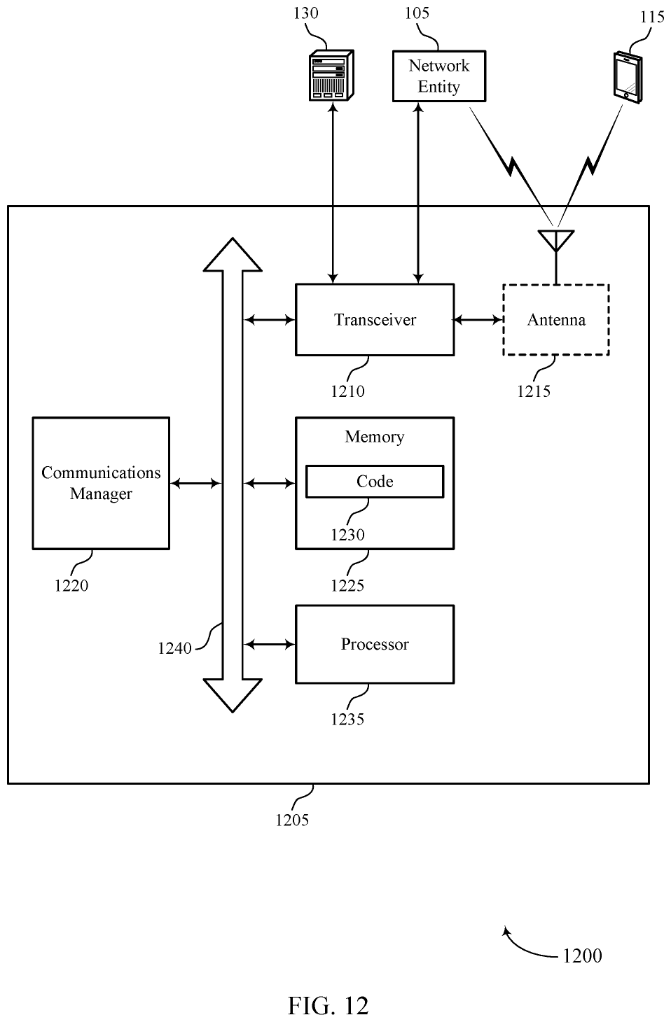

FIG. 12 shows a diagram of a system 1200 including a device 1205 that supports SBFD in FDD bands in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting SBFD in FDD bands). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The communications manager 1220 may be configured as or otherwise support a means for determining one or more rules for SBFD signaling to be communicated to one or more user equipments (UEs) via the duplexing gap. The communications manager 1220 may be configured as or otherwise support a means for performing wireless communications with the one or more UEs via the duplexing gap according to a SBFD mode and based on the one or more rules.

By including or configuring the communications manager 1220 in accordance with examples as described herein, the device 1205 may support techniques for effectively utilizing available system resources, including duplexing gaps, resulting in more efficient use of system resources, decreased system delays and latency, improved throughput, and improved user experiences.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of SBFD in FDD bands as described herein, or the processor 1235 and the memory 1225 may be otherwise configured to perform or support such operations.

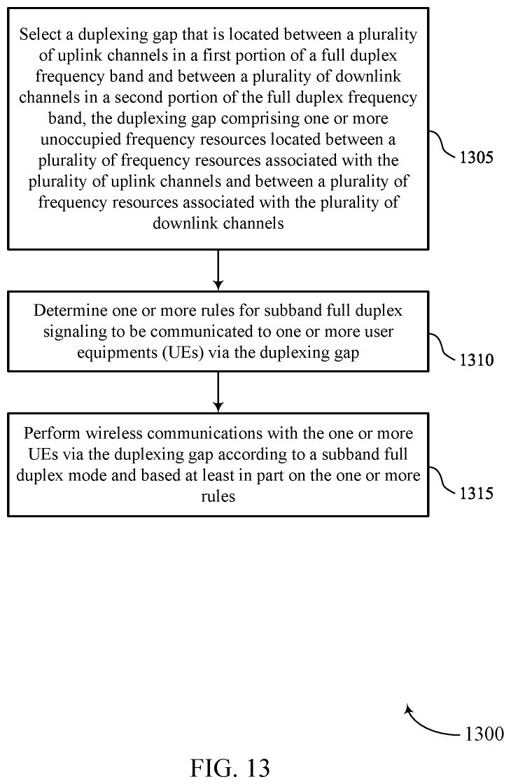

FIG. 13 shows a flowchart illustrating a method 1300 that supports SBFD in FDD bands in accordance with one or more aspects of the present disclosure. The operations of the method 1300 may be implemented by a network entity or its components as described herein. For example, the operations of the method 1300 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1305, the method may include selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The operations of 1305 may be performed in accordance with examples as disclosed herein. In some examples, aspects of the operations of 1305 may be performed by a channel selection manager 1125 as described with reference to FIG. 11.

At 1310, the method may include determining one or more rules for SBFD signaling to be communicated to one or more user equipments (UEs) via the duplexing gap. The operations of 1310 may be performed in accordance with examples as disclosed herein. In some examples, aspects of the operations of 1310 may be performed by a duplexing rules manager 1130 as described with reference to FIG. 11.

At 1315, the method may include performing wireless communications with the one or more UEs via the duplexing gap according to a SBFD mode and based on the one or more rules. The operations of 1315 may be performed in accordance with examples as disclosed herein. In some examples, aspects of the operations of 1315 may be performed by an SBFD communication manager 1135 as described with reference to FIG. 11.

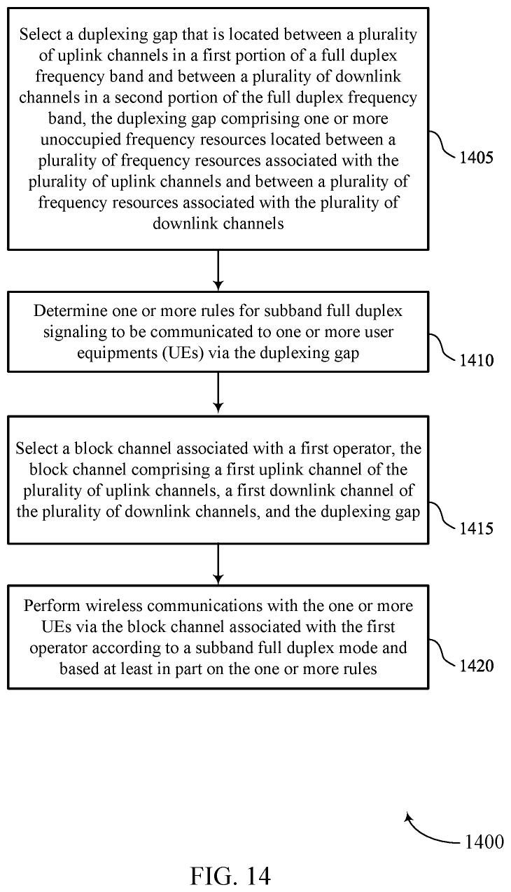

FIG. 14 shows a flowchart illustrating a method 1400 that supports SBFD in FDD bands in accordance with one or more aspects of the present disclosure. The operations of the method 1400 may be implemented by a network entity or its components as described herein. For example, the operations of the method 1400 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1405, the method may include selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The operations of 1405 may be performed in accordance with examples as disclosed herein. In some examples, aspects of the operations of 1405 may be performed by a channel selection manager 1125 as described with reference to FIG. 11.

At 1410, the method may include determining one or more rules for SBFD signaling to be communicated to one or more user equipments (UEs) via the duplexing gap. The operations of 1410 may be performed in accordance with examples as disclosed herein. In some examples, aspects of the operations of 1410 may be performed by a duplexing rules manager 1130 as described with reference to FIG. 11.

At 1415, the method may include selecting a block channel associated with a first operator, the block channel including a first uplink channel of the set of multiple uplink channels, a first downlink channel of the set of multiple downlink channels, and the duplexing gap. The operations of 1415 may be performed in accordance with examples as disclosed herein. In some examples, aspects of the operations of 1415 may be performed by a block channel manager 1140 as described with reference to FIG. 11.

At 1420, the method may include performing wireless communications with the one or more UEs via the block channel associated with the first operator according to a SBFD mode and based at least in part on the one or more rules. The operations of 1420 may be performed in accordance with examples as disclosed herein. In some examples, aspects of the operations of 1420 may be performed by an SBFD communication manager 1135 as described with reference to FIG. 11.

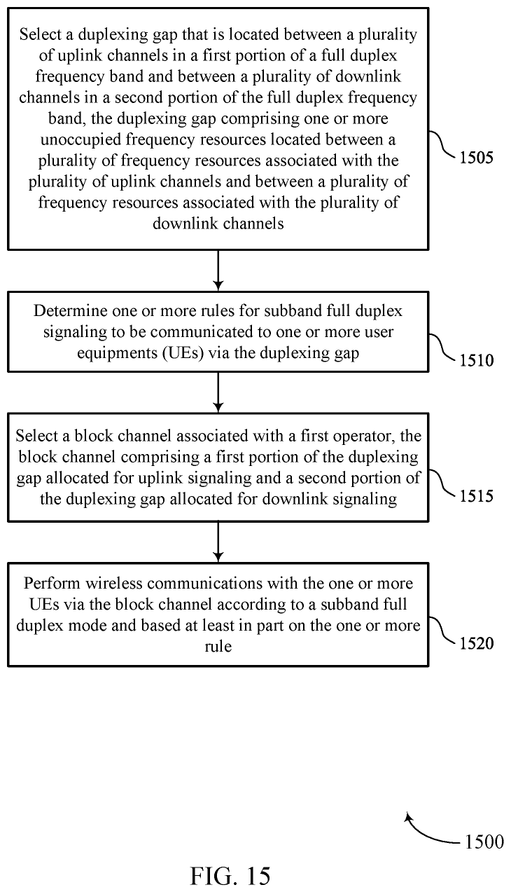

FIG. 15 shows a flowchart illustrating a method 1500 that supports SBFD in FDD bands in accordance with one or more aspects of the present disclosure. The operations of the method 1500 may be implemented by a network entity or its components as described herein. For example, the operations of the method 1500 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1505, the method may include selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The operations of 1505 may be performed in accordance with examples as disclosed herein. In some examples, aspects of the operations of 1505 may be performed by a channel selection manager 1125 as described with reference to FIG. 11.

At 1510, the method may include determining one or more rules for SBFD signaling to be communicated to one or more user equipments (UEs) via the duplexing gap. The operations of 1510 may be performed in accordance with examples as disclosed herein. In some examples, aspects of the operations of 1510 may be performed by a duplexing rules manager 1130 as described with reference to FIG. 11.

At 1515, the method may include selecting a block channel associated with a first operator, the block channel including a first portion of the duplexing gap allocated for uplink signaling and a second portion of the duplexing gap allocated for downlink signaling. The operations of 1515 may be performed in accordance with examples as disclosed herein. In some examples, aspects of the operations of 1515 may be performed by a block channel manager 1140 as described with reference to FIG. 11.

At 1520, the method may include performing wireless communications with the one or more UEs via the block channel according to a SBFD mode and based at least in part on the one or more rules. The operations of 1520 may be performed in accordance with examples as disclosed herein. In some examples, aspects of the operations of 1520 may be performed by an SBFD communication manager 1135 as described with reference to FIG. 11.

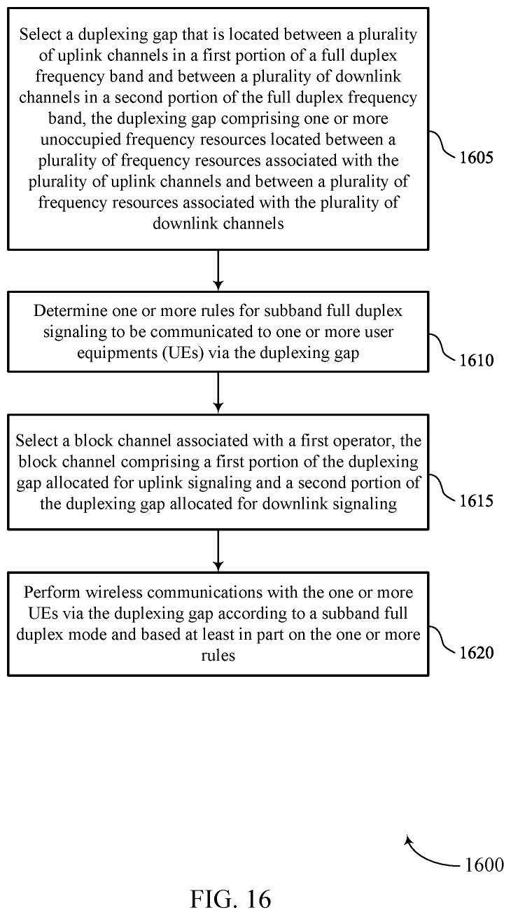

FIG. 16 shows a flowchart illustrating a method 1600 that supports SBFD in FDD bands in accordance with one or more aspects of the present disclosure. The operations of the method 1600 may be implemented by a network entity or its components as described herein. For example, the operations of the method 1600 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1605, the method may include selecting a duplexing gap that is located between a set of multiple uplink channels in a first portion of a full duplex frequency band and between a set of multiple downlink channels in a second portion of the full duplex frequency band, the duplexing gap including one or more unoccupied frequency resources located between a set of multiple frequency resources associated with the set of multiple uplink channels and between a set of multiple frequency resources associated with the set of multiple downlink channels. The operations of 1605 may be performed in accordance with examples as disclosed herein. In some examples, aspects of the operations of 1605 may be performed by a channel selection manager 1125 as described with reference to FIG. 11.

At 1610, the method may include determining one or more rules for SBFD signaling to be communicated to one or more user equipments (UEs) via the duplexing gap. The operations of 1610 may be performed in accordance with examples as disclosed herein. In some examples, aspects of the operations of 1610 may be performed by a duplexing rules manager 1130 as described with reference to FIG. 11.

At 1615, the method may include selecting a block channel associated with a first operator, the block channel including a first portion of the duplexing gap allocated for uplink signaling and a second portion of the duplexing gap allocated for downlink signaling. The operations of 1615 may be performed in accordance with examples as disclosed herein. In some examples, aspects of the operations of 1615 may be performed by a block channel manager 1140 as described with reference to FIG. 11.

At 1620, the method may include performing wireless communications with the one or more UEs via the block channel according to a SBFD mode and based on the one or more rules. The operations of 1620 may be performed in accordance with examples as disclosed herein. In some examples, aspects of the operations of 1620 may be performed by an SBFD communication manager 1135 as described with reference to FIG. 11.

The following provides an overview of aspects of the present disclosure:

Aspect 1: A method for wireless communications at a network entity, comprising: selecting a duplexing gap that is located between a plurality of uplink channels in a first portion of a full duplex frequency band and between a plurality of downlink channels in a second portion of the full duplex frequency band, the duplexing gap comprising one or more unoccupied frequency resources located between a plurality of frequency resources associated with the plurality of uplink channels and between a plurality of frequency resources associated with the plurality of downlink channels; determining one or more rules for subband full duplex (SBFD) signaling to be communicated to one or more user equipments (UEs) via the duplexing gap; and performing wireless communications with the one or more UEs via the duplexing gap according to a SBFD mode and based at least in part on the one or more rules.

Aspect 2: The method of aspect 1, further comprising: selecting a block channel associated with a first operator, the block channel comprising a first uplink channel of the plurality of uplink channels, a first downlink channel of the plurality of downlink channels, and the duplexing gap, wherein performing the wireless communications via at least the duplexing gap comprises performing the wireless communications via the block channel.

Aspect 3: The method of aspect 2, wherein performing the wireless communications comprises: transmitting downlink signaling via the duplexing gap, the duplexing gap comprising a second downlink channel of the block channel according to the one or more rules, wherein the first uplink channel is adjacent to the duplexing gap.

Aspect 4: The method of any of aspects 2 through 3, wherein performing the wireless communications comprises: receiving uplink signaling via the duplexing gap, the duplexing gap comprising a second uplink channel of the block channel according to the one or more rules, wherein the first downlink channel is adjacent to the duplexing gap.

Aspect 5: The method of any of aspects 2 through 4, wherein performing the wireless communications comprises: performing the wireless communications according to an emissions threshold.

Aspect 6: The method of any of aspects 2 through 5, further comprising: refraining from performing wireless communications via a guard band located in a portion of the duplexing gap.

Aspect 7: The method of any of aspects 1 through 6, further comprising: selecting a block channel associated with a first operator, the block channel comprising a first portion of the duplexing gap allocated for uplink signaling and a second portion of the duplexing gap allocated for downlink signaling, wherein performing the wireless communications via at least the duplexing gap comprises performing the wireless communications via the block channel.

Aspect 8: The method of aspect 7, wherein the first portion of the duplexing gap is adjacent to a first uplink channel of the plurality of uplink channels that is associated with a second operator according to the one or more rules, and the second portion of the duplexing gap is adjacent to a first downlink channel of the plurality of downlink channels that is associated with a third operator according to the one or more rules.

Aspect 9: The method of any of aspects 7 through 8, further comprising: refraining from performing wireless communications via a guard band located between the first portion of the duplexing gap and the second portion of the duplexing gap.

Aspect 10: The method of any of aspects 1 through 9, further comprising: selecting a block channel associated with a first operator, the block channel comprising a first portion of the duplexing gap allocated for uplink signaling and a second portion of the duplexing gap allocated for downlink signaling, wherein performing the wireless communications via at least the duplexing gap comprises performing the wireless communications via the first portion of the duplexing gap or the second portion of the duplexing gap based at least in part on the one or more rules.

Aspect 11: The method of aspect 10, wherein performing the wireless communications comprises: performing downlink signaling via the second portion of the duplexing gap, wherein the second portion of the duplexing gap is adjacent to a first downlink channel of the plurality of downlink channels that is associated with the first operator, and wherein the first portion of the duplexing gap is adjacent to a first uplink channel of the plurality of uplink channels that is associated with a second operator; and refraining from performing uplink signaling via the first portion of the duplexing gap according to the one or more rules.

Aspect 12: The method of any of aspects 10 through 11, wherein performing the wireless communications comprises: performing uplink signaling via the first portion of the duplexing gap, wherein the first portion of the duplexing gap is adjacent to a first uplink channel of the plurality of uplink channels that is associated with the first operator, and wherein the second portion of the duplexing gap is adjacent to a first downlink channel of the plurality of downlink channels that is associated with a second operator; and refraining from performing downlink signaling via the second portion of the duplexing gap according to the one or more rules.

Aspect 13: An apparatus for wireless communications at a network entity, comprising a processor; memory coupled with the processor; and instructions stored in the memory and executable by the processor to cause the apparatus to perform a method of any of aspects 1 through 12.

Aspect 14: An apparatus for wireless communications at a network entity, comprising at least one means for performing a method of any of aspects 1 through 12.

Aspect 15: A non-transitory computer-readable medium storing code for wireless communications at a network entity, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a network entity, comprising:
selecting a duplexing gap that is located between a plurality of uplink channels in a first portion of a full duplex frequency band and between a plurality of downlink channels in a second portion of the full duplex frequency band, the duplexing gap comprising one or more unoccupied frequency resources located between a plurality of frequency resources associated with the plurality of uplink channels and between a plurality of frequency resources associated with the plurality of downlink channels;
determining one or more rules for subband full duplex signaling to be communicated to one or more user equipments (UEs) via the duplexing gap; and
performing wireless communications with the one or more UEs via the duplexing gap according to a subband full duplex mode and based at least in part on the one or more rules.

2. The method of claim 1, further comprising:
selecting a block channel associated with a first operator, the block channel comprising a first uplink channel of the plurality of uplink channels, a first downlink channel of the plurality of downlink channels, and the duplexing gap, wherein performing the wireless communications via at least the duplexing gap comprises performing the wireless communications via the block channel.

3. The method of claim 2, wherein performing the wireless communications comprises:
transmitting downlink signaling via the duplexing gap, the duplexing gap comprising a second downlink channel of the block channel according to the one or more rules, wherein the first uplink channel is adjacent to the duplexing gap.

4. The method of claim 2, wherein performing the wireless communications comprises:
receiving uplink signaling via the duplexing gap, the duplexing gap comprising a second uplink channel of the block channel according to the one or more rules, wherein the first downlink channel is adjacent to the duplexing gap.

5. The method of claim 2, wherein performing the wireless communications comprises:
performing the wireless communications according to an emissions threshold.

6. The method of claim 2, further comprising:
refraining from performing wireless communications via a guard band located in a portion of the duplexing gap.

7. The method of claim 1, further comprising:
selecting a block channel associated with a first operator, the block channel comprising a first portion of the duplexing gap allocated for uplink signaling and a second portion of the duplexing gap allocated for downlink signaling, wherein performing the wireless communications via at least the duplexing gap comprises performing the wireless communications via the block channel.

8. The method of claim 7, wherein:
the first portion of the duplexing gap is adjacent to a first uplink channel of the plurality of uplink channels that is associated with a second operator according to the one or more rules, and
the second portion of the duplexing gap is adjacent to a first downlink channel of the plurality of downlink channels that is associated with a third operator according to the one or more rules.

9. The method of claim 7, further comprising:
refraining from performing wireless communications via a guard band located between the first portion of the duplexing gap and the second portion of the duplexing gap.

10. The method of claim 1, further comprising:
selecting a block channel associated with a first operator, the block channel comprising a first portion of the duplexing gap allocated for uplink signaling and a second portion of the duplexing gap allocated for downlink signaling, wherein performing the wireless communications via at least the duplexing gap comprises performing the wireless communications via the first portion of the duplexing gap or the second portion of the duplexing gap based at least in part on the one or more rules.

11. The method of claim 10, wherein performing the wireless communications comprises:
performing downlink signaling via the second portion of the duplexing gap, wherein the second portion of the duplexing gap is adjacent to a first downlink channel of the plurality of downlink channels that is associated with the first operator, and wherein the first portion of the duplexing gap is adjacent to a first uplink channel of the plurality of uplink channels that is associated with a second operator; and
refraining from performing uplink signaling via the first portion of the duplexing gap according to the one or more rules.

12. The method of claim 10, wherein performing the wireless communications comprises:
performing uplink signaling via the first portion of the duplexing gap, wherein the first portion of the duplexing gap is adjacent to a first uplink channel of the plurality of uplink channels that is associated with the first operator, and wherein the second portion of the duplexing gap is adjacent to a first downlink channel of the plurality of downlink channels that is associated with a second operator; and
refraining from performing downlink signaling via the second portion of the duplexing gap according to the one or more rules.

13. An apparatus for wireless communications at a network entity, comprising:
a processor;
memory coupled with the processor; and
instructions stored in the memory and executable by the processor to cause the apparatus to:
select a duplexing gap that is located between a plurality of uplink channels in a first portion of a full duplex frequency band and between a plurality of downlink channels in a second portion of the full duplex frequency band, the duplexing gap comprising one or more unoccupied frequency resources located between a plurality of frequency resources associated with the plurality of uplink channels and between a plurality of frequency resources associated with the plurality of downlink channels;
determine one or more rules for subband full duplex signaling to be communicated to one or more user equipments (UEs) via the duplexing gap; and
perform wireless communications with the one or more UEs via the duplexing gap according to a subband full duplex mode and based at least in part on the one or more rules.

14. The apparatus of claim 13, wherein the instructions are further executable by the processor to cause the apparatus to:
select a block channel associated with a first operator, the block channel comprising a first uplink channel of the plurality of uplink channels, a first downlink channel of the plurality of downlink channels, and the duplexing gap, wherein performing the wireless communications via at least the duplexing gap comprises performing the wireless communications via the block channel.

15. The apparatus of claim 14, wherein the instructions to perform the wireless communications are executable by the processor to cause the apparatus to:
transmit downlink signaling via the duplexing gap, the duplexing gap comprising a second downlink channel of the block channel according to the one or more rules, wherein the first uplink channel is adjacent to the duplexing gap.

16. The apparatus of claim 14, wherein the instructions to perform the wireless communications are executable by the processor to cause the apparatus to:
receive uplink signaling via the duplexing gap, the duplexing gap comprising a second uplink channel of the block channel according to the one or more rules, wherein the first downlink channel is adjacent to the duplexing gap.

17. The apparatus of claim 14, wherein the instructions to perform the wireless communications are executable by the processor to cause the apparatus to:
perform the wireless communications according to an emissions threshold.

18. The apparatus of claim 14, wherein the instructions are further executable by the processor to cause the apparatus to:
refrain from performing wireless communications via a guard band located in a portion of the duplexing gap.

19. The apparatus of claim 13, wherein the instructions are further executable by the processor to cause the apparatus to:
select a block channel associated with a first operator, the block channel comprising a first portion of the duplexing gap allocated for uplink signaling and a second portion of the duplexing gap allocated for downlink signaling, wherein performing the wireless communications via at least the duplexing gap comprises performing the wireless communications via the block channel.

20. The apparatus of claim 19, wherein:
the first portion of the duplexing gap is adjacent to a first uplink channel of the plurality of uplink channels that is associated with a second operator according to the one or more rules, and
the second portion of the duplexing gap is adjacent to a first downlink channel of the plurality of downlink channels that is associated with a third operator according to the one or more rules.

21. The apparatus of claim 19, wherein the instructions are further executable by the processor to cause the apparatus to:
refrain from performing wireless communications via a guard band located between the first portion of the duplexing gap and the second portion of the duplexing gap.

22. The apparatus of claim 13, wherein the instructions are further executable by the processor to cause the apparatus to:
select a block channel associated with a first operator, the block channel comprising a first portion of the duplexing gap allocated for uplink signaling and a second portion of the duplexing gap allocated for downlink signaling, wherein performing the wireless communications via at least the duplexing gap comprises performing the wireless communications via the first portion of the duplexing gap or the second portion of the duplexing gap based at least in part on the one or more rules.

23. The apparatus of claim 22, wherein the instructions to perform the wireless communications are executable by the processor to cause the apparatus to:
perform downlink signaling via the second portion of the duplexing gap, wherein the second portion of the duplexing gap is adjacent to a first downlink channel of the plurality of downlink channels that is associated with the first operator, and wherein the first portion of the duplexing gap is adjacent to a first uplink channel of the plurality of uplink channels that is associated with a second operator; and
refrain from performing uplink signaling via the first portion of the duplexing gap according to the one or more rules.

24. The apparatus of claim 22, wherein the instructions to perform the wireless communications are executable by the processor to cause the apparatus to:
perform uplink signaling via the first portion of the duplexing gap, wherein the first portion of the duplexing gap is adjacent to a first uplink channel of the plurality of uplink channels that is associated with the first operator, and wherein the second portion of the duplexing gap is adjacent to a first downlink channel of the plurality of downlink channels that is associated with a second operator; and
refrain from performing downlink signaling via the second portion of the duplexing gap according to the one or more rules.

25. A non-transitory computer-readable medium storing code for wireless communications at a network entity, the code comprising instructions executable by a processor to:
select a duplexing gap that is located between a plurality of uplink channels in a first portion of a full duplex frequency band and between a plurality of downlink channels in a second portion of the full duplex frequency band, the duplexing gap comprising one or more unoccupied frequency resources located between a plurality of frequency resources associated with the plurality of uplink channels and between a plurality of frequency resources associated with the plurality of downlink channels;
determine one or more rules for subband full duplex signaling to be communicated to one or more user equipments (UEs) via the duplexing gap; and
perform wireless communications with the one or more UEs via the duplexing gap according to a subband full duplex mode and based at least in part on the one or more rules.

26. The non-transitory computer-readable medium of claim 25, wherein the instructions are further executable by the processor to:
select a block channel associated with a first operator, the block channel comprising a first uplink channel of the plurality of uplink channels, a first downlink channel of the plurality of downlink channels, and the duplexing gap, wherein performing the wireless communications via at least the duplexing gap comprises performing the wireless communications via the block channel.

27. The non-transitory computer-readable medium of claim 26, wherein the instructions to perform the wireless communications are executable by the processor to:
transmit downlink signaling via the duplexing gap, the duplexing gap comprising a second downlink channel of the block channel according to the one or more rules, wherein the first uplink channel is adjacent to the duplexing gap.

28. The non-transitory computer-readable medium of claim 26, wherein the instructions to perform the wireless communications are executable by the processor to:
receive uplink signaling via the duplexing gap, the duplexing gap comprising a second uplink channel of the block channel according to the one or more rules, wherein the first downlink channel is adjacent to the duplexing gap.

29. The non-transitory computer-readable medium of claim 25, wherein the instructions are further executable by the processor to:
select a block channel associated with a first operator, the block channel comprising a first portion of the duplexing gap allocated for uplink signaling and a second portion of the duplexing gap allocated for downlink signaling, wherein performing the wireless communications via at least the duplexing gap comprises performing the wireless communications via the block channel.

30. An apparatus for wireless communications at a network entity, comprising:
means for selecting a duplexing gap that is located between a plurality of uplink channels in a first portion of a full duplex frequency band and between a plurality of downlink channels in a second portion of the full duplex frequency band, the duplexing gap comprising one or more unoccupied frequency resources located between a plurality of frequency resources associated with the plurality of uplink channels and between a plurality of frequency resources associated with the plurality of downlink channels;
means for determining one or more rules for subband full duplex signaling to be communicated to one or more user equipments (UEs) via the duplexing gap; and
means for performing wireless communications with the one or more UEs via the duplexing gap according to a subband full duplex mode and based at least in part on the one or more rules.
